(19) United States
(12) Patent Application Publication
(10) Pub. No.: US 2017/0162047 A1
(43) Pub. Date: Jun. 8, 2017

(54) COLLISION PROTECTION SYSTEM FOR A PARKED MOTOR VEHICLE

(71) Applicant: FORD GLOBAL TECHNOLIGIES, LLC, Dearborn, MI (US)

(72) Inventor: Mauricio Garcia Lopez, Mexico City (MX)

(21) Appl. No.: 14/959,471

(22) Filed: Dec. 4, 2015

(51) Int. Cl. G08G 1/16; B60Q 1/52

(52) U.S. Cl. CPC G08G 1/16; B60Q 1/525

(57) ABSTRACT

A collision protection system is provided for a parked motor vehicle. That collision protection system includes a warning device, a sensor for detecting an approaching motor vehicle and a controller. The controller is configured to activate the warning device in response to a signal from the sensor indicating that the approaching motor vehicle is within a predetermined distance of the parked motor vehicle. A related method is also provided.

### TECHNICAL FIELD

This document relates generally to the motor vehicle equipment field and, more particularly, to a system for protecting a parked motor vehicle from a collision including, particularly, contact from another motor vehicle being parked adjacent to the motor vehicle equipped with the collision protection system.

### BACKGROUND

A motor vehicle generally represents a very significant investment. For most individuals a motor vehicle represents the second largest investment an individual will make, ranking only behind a home.

Unfortunately, many motor vehicles are damaged in parking lots when an individual parking another motor vehicle bumps into or collides with the parked motor vehicle. At a minimum, such an incident can lead to scratches and paint damage. Under other circumstances body panels may be dented and crushed due to contact from another motor vehicle.

This document relates to a collision protection system for a parked motor vehicle that is explicitly designed to warn an individual parking another vehicle adjacent to the parked motor vehicle when that individual is within a predetermined distance of the parked motor vehicle and there is a greater potential for vehicle to vehicle contact.

### SUMMARY

In accordance with the purposes and benefits described herein, a collision protection system for a parked motor vehicle is provided. That collision protection system comprises a warning device, a sensor for detecting an approaching motor vehicle and a controller. The controller is configured to activate the warning device in response to a signal from the sensor indicating that the approaching motor vehicle is within a predetermine distance of the parked motor vehicle. This warning informs the driver of the vehicle being parked to come no closer to the parked motor vehicle thereby avoiding contact between the two vehicles.

In one possible embodiment, the warning device and the sensor are provided at a first end of the parked motor vehicle. In another possible embodiment, the collision protection system includes a second sensor and a second warning device at a second end of the parked motor vehicle.

The warning device may comprise a warning light and the controller may be configured to increase the intensity of the warning light as the approaching motor vehicle comes closer to the parked motor vehicle. Further, the controller may be configured to increase a flash rate of the warning light as the approaching motor vehicle comes closer to the parked motor vehicle. In one possible embodiment, the controller is configured to increase both the intensity and the flash rate of the warning light as the approaching motor vehicle comes closer to the parked motor vehicle.

The controller may also be configured to have a transmission state data input and only activate the warning device when a transmission of the motor vehicle is in park. Further the controller may be configured to have a battery voltage state data input and deactivate the collision protection system when a battery voltage state of the parked motor vehicle falls to a predetermined level.

The controller may also be configured to have an ignition state data input and only activate the collision protection system of the parked motor vehicle when the ignition of the motor vehicle is off.

In accordance with yet another aspect, a method is provided for protecting a parked motor vehicle from collision damage. That method may be broadly described as comprising the steps of monitoring, by sensor, for an approaching motor vehicle and activating, by controller, a warning device whenever the approaching motor vehicle is within a predetermined distance of the parked motor vehicle.

Where the warning device is a warning light, the method may include flashing the warning light whenever the approaching motor vehicle is within the predetermined distance of the parked motor vehicle. Still further, the method may include increasing the flashing speed of the warning light as the approaching motor vehicle comes closer to the parked motor vehicle. Further, the method may include increasing the intensity of the warning light as the approaching motor vehicle comes closer to the parked motor vehicle.

In addition the method may include monitoring a transmission state of the motor vehicle and activating the warning light only when the transmission of the parked motor vehicle is in park. Further the method may include monitoring the ignition state of the parked motor vehicle and activating the warning light only when an ignition of the parked motor vehicle is off.

Still further the method may include the step of monitoring a battery voltage state of the parked motor vehicle and deactivating, by the controller, the warning light when the battery voltage state of the parked motor vehicle falls below the predetermined level.

In the following description, there are shown and described several preferred embodiments of the collision protection system and the related method of protecting a parked motor vehicle from collision damage. As it should be realized, the system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the collision protection system and together with the description serve to explain certain principles thereof. In the drawing figures:

FIG. 1 is a schematic block diagram of the collision protection system.

FIG. 2 illustrates the operation of the collision protection system when it warns the operator of an approaching vehicle that he should not continue to approach the parked vehicle if contact with the parked vehicle is to be avoided.

Reference will now be made in detail to the present preferred embodiments of the collision protection system, examples of which are illustrated in the accompanying drawing figures.

### DETAILED DESCRIPTION

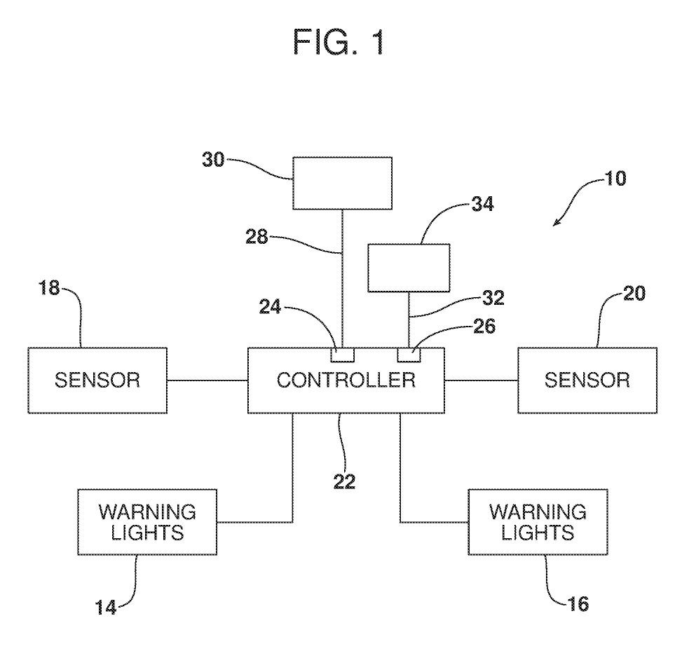

Reference is now made to FIG. 1 which schematically illustrates the collision protection system 10. In the illustrated embodiment, that collision protection system 10 includes a warning device in the form of two warning lights 14, 16.

As further illustrated, the collision protection system 10 includes a first sensor 18 and a second sensor 20. As will be apparent from the description below, these sensors 18, 20 are provided for detecting an approaching motor vehicle when the motor vehicle equipped with the collision protection system 10 is in a parked state. In one possible embodiment, the first and second sensors 18, 20 are proximity sensors of substantially any appropriate type known in the art.

As further illustrated in FIG. 1, the collision protection system 10 also includes a controller 22. The controller 22 comprises a computing device such as a dedicated microprocessor or electronic control unit (ECU) operating in accordance with appropriate control software instructions. In one possible embodiment, the controller 22 may comprise the body control module or BCM of the motor vehicle. As is known in the art, the BCM may perform a number of interior body electrically based functions including, for example, interior locking, no key entry, interior light, exterior light, windshield wiper control and the like. In some embodiments, the BCM may also function to control the entertainment functions (e.g., radio, CD player and communications such as telephone and internet communications over a wireless network). In some embodiments the BCM is connected by a communication bus (not shown) to other control modules (also not shown) that provide one or more of these additional functions. In any of these possible embodiments, a controller 22 may comprise one or more processors, one or more memories and one or more network interfaces that communicate with each other over a communication bus.

In the illustrated embodiment the first warning light 14 and the first sensor 18 are provided at a first end of the motor vehicle while the second warning light 16 and the second sensor 20 are provided at the second of the motor vehicle. As will be apparent from the following description, the warning lights 14, 16 and sensors 18, 20 operate through the controller 22 to protect the first and second ends of the motor vehicle from collision damage when the motor vehicle is parked. In other possible embodiments of the collision protection system 10, additional sensors 18, 20 and warning lights 14, 16 are provided in order to protect all sides of the motor vehicle from potential collision damage as often presently occurs in the parking lot setting.

As further illustrated in FIG. 1, the controller 22 is configured to include a first data input 24 and a second data input 26. In one possible embodiment, the data input 24 functions as a transmission state data input and is connected via the control line 28 to a transmission state sensor for transmission control module 30 that provides transmission data to the controller 22 through the control line and that data input. In such an embodiment, the controller 22 may be configured to only activate the collision protection system 10 when the transmission of the motor vehicle is in park.

In another possible embodiment, the data input 24 functions as an ignition state data input which is connected via the control line 28 to an ignition state sensor or an ignition control module 30 that provides ignition state data to the controller. In such an embodiment, the controller 22 may be configured to only activate the collision protection system 10 when the ignition of the motor vehicle is on the off state.

In one possible embodiment, the data input 26 is configured to function as a battery voltage state data input. Thus, the data input 26 is connected via the control line 32 to a battery voltage sensor for another control module 34 that monitors battery voltage so the data respecting the voltage state of the battery is provided to the controller 22. In such an embodiment, the controller 22 may be configured to deactivate the collision protection system 10 when the battery voltage state of the parked motor vehicle falls to or below a predetermined voltage level. This functions to preserve sufficient electric energy in the battery to allow the operator to subsequently start the motor vehicle.

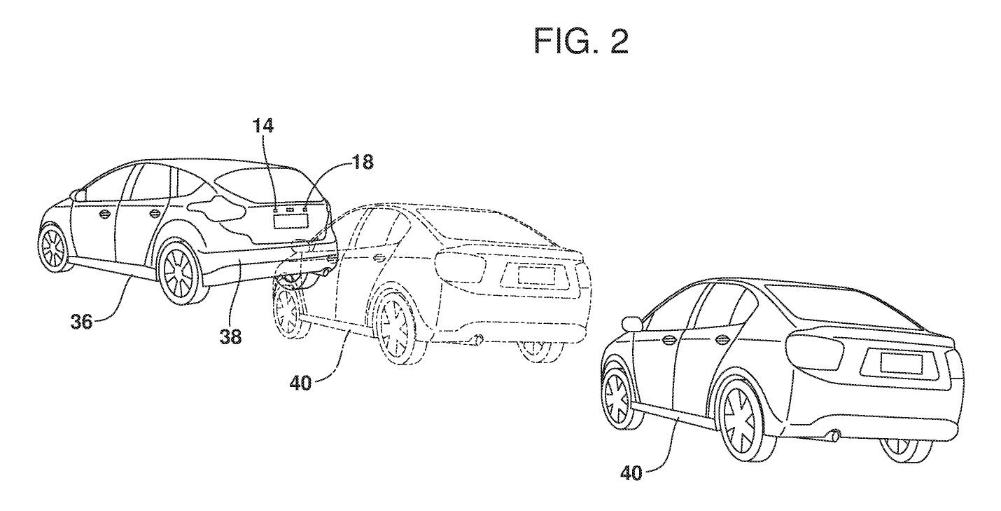

The operation of the collision protection system 10 will now be described in detail with reference to FIG. 2. As illustrated, the parked motor vehicle 36 is equipped with the collision protection system 10. In this embodiment, the rear end 38 of the motor vehicle 36 is equipped with the proximity sensor 18 and the warning light 14. It should be noted that the warning light 14 may be a warning light dedicated to the collision protection system, the existing tail lights of the motor vehicle 36 or both a dedicated warning light and the tail lights of the motor vehicle.

The collision protection system 10 of the motor vehicle 36 is activated when the transmission of the motor vehicle 36 is in park and/or the ignition system of the motor vehicle 36 is off. As noted above, data respecting the transmission state and/or ignition state of the motor vehicle 36 is provided to the controller 22 from the sensor/control module 30 through the control line 28 to the data input 24.

When the collision protection system 10 is activated, the sensor 18 functions to monitor and detect an approaching motor vehicle 40. In the illustrated embodiment, the sensor 18 first detects that motor vehicle when it is in the full line position illustrated in FIG. 2. This may be, for example, at a distance of between about 1.5 and about 1.0 meters from the rear end 38 of the parked vehicle 36.

The sensor 18 continues to provide data to the controller 22 indicating the distance between the approaching motor vehicle 40 and the rear end 38 of the parked motor vehicle 36. Once the motor vehicle 40 comes within a predetermined distance of the rear end 38 of the parked motor vehicle 36 as illustrated in phantom line in FIG. 2, the controller 22 activates the warning light 14. That distance may be, for example, between 1.0 and 0.8 meters.

In one possible embodiment, the controller 22 is configured to increase the intensity of the warning light if the approaching motor vehicle 40 continues to come closer to the rear end 38 of the parked motor vehicle 36. In one possible embodiment, the controller 22 is configured to increase the flashing rate of the warning light 14 if the approaching motor vehicle 40 continues to come closer to the rear end 30 of the parked motor vehicle 36. In still another possible embodiment, the controller 22 is configured to increase both the intensity and a flashing rate of the warning light 14 if the approaching motor vehicle 40 continues to come closer to the rear end 38 of the parked motor vehicle 36. Further, the controller 22 may be configured to reduce the rate and/or intensity of the warning light 14 as the motor vehicle 40 recedes from the parked vehicle 36. The controller 22 may also be configured to extinguish the warning light 14 when no further motion of the motor vehicle 40 is detected for a predetermined period of time.

In any of these embodiments, the warning light 14 functions to warn the driver of the approaching motor vehicle 40 that he is coming too close to the parked motor vehicle 36 and that there is a potential for unwanted contact. Advantageously, the collision protection system 10 described herein significantly reduces the potential for such contact and resulting damage to the motor vehicle 36.

As should further be appreciated, a method is provided for protecting a parked motor vehicle 36 from collision damage. That method includes the steps of monitoring, by sensor 18, 20, for an approaching motor vehicle 40 and activating, by controller 22, a warning device 14, 16 whenever the approaching motor vehicle is within a predetermined/trigger distance of the parked motor vehicle 36. That method may include flashing the warning light 14, 16 whenever the approaching motor vehicle 40 is within the predetermined distance of the parked motor vehicle 36. Further, the method may include increasing the flashing speed and/or increasing the intensity of the warning light 14, 16 as the approaching motor vehicle 40 comes closer to the parked motor vehicle 36.

Still further, the method may include monitoring a transmission state of the parked motor vehicle 36 and activating the collision protection system only when a transmission of the parked motor vehicle is in park. Further, the method may include monitoring an ignition state of the parked motor vehicle 36 and activating the collision protection system 10 only when an ignition of the parked motor vehicle is off.

Still further the method may include monitoring a battery voltage state of the parked motor vehicle 36 and deactivating the collision protection system 10 when a battery voltage state of the parked motor vehicle falls below a predetermined level.

The foregoing has been presented for purposes of illustration and description. It is not intended to be exhaustive or to limit the embodiments to the precise form disclosed. Obvious modifications and variations are possible in light of the above teachings. For example, in the illustrated embodiment, the warning device comprises a first warning light 14 and a second warning light 16 provided at first and second/front and rear ends of the motor vehicle 36. It should be appreciated that the warning device 12 may also comprise an audio signal device such as a horn or a synthesized voice processor and may provide an appropriate warning to the driver of an approaching vehicle. Further, the collision protection system 10 may include any number of sensors 18, 20 and any appropriate warning device 14, 16 necessary to monitor the entire perimeter of the motor vehicle 36 and warn the driver in an approaching vehicle 40 when he is getting too close to the motor vehicle 36 so as to protect the motor vehicle 36 from contact.

All such modifications and variations are within the scope of the appended claims when interpreted in accordance with the breadth to which they are fairly, legally and equitably entitled.

1. A collision protection system for a parked motor vehicle, comprising:
a warning device;
a sensor for detecting an approaching motor vehicle; and
a controller configured to activate said warning device in response to a signal from said sensor indicating that said approaching motor vehicle is within a predetermined distance of said parked motor vehicle, wherein said controller is configured to have a battery voltage state data input and deactivate said collision protection system when a battery voltage state of said parked motor vehicle falls to a predetermined level.

2. The collision protection system of claim 1 wherein said warning device and said sensor are provided at a first end of said parked motor vehicle.

3. The collision protection system of claim 2, further including a second sensor and a second warning device at a second end of said parked motor vehicle.

4. The collision protection system of claim 1, wherein said warning device is a warning light and said controller is configured to increase an intensity of said warning light as said approaching motor vehicle comes closer to said parked motor vehicle.

5. The collision protection system of claim 1, wherein said warning device is a warning light and said controller is configured to increase a flash rate of said warning light as said approaching motor vehicle comes closer to said parked motor vehicle.

6. The collision protection system of claim 1, wherein said controller is configured to have a transmission state data input and only activate said warning device when a transmission of said motor vehicle is in park.

7. (canceled)

8. The collision protection system of claim 1, wherein said controller is configured to have an ignition state data input and activate said collision protection system when said ignition is off.

9. (canceled)

10. A motor vehicle equipped with said collision protection system of claim 1.

11. A method of protecting a parked motor vehicle from collision damage by means of a collision protection system, comprising:
monitoring, by sensor, for an approaching motor vehicle;
activating, by controller, a warning device whenever said approaching motor vehicle is within a predetermined distance of said parked motor vehicle; and
monitoring a battery voltage state of said parked motor vehicle and deactivating the collision protection system when a battery voltage state of said parked motor vehicle falls below a predetermined level.

12. The method of claim 11, wherein said warning device is a warning light and further including flashing said warning light whenever said approaching motor vehicle is within said predetermined distance of said parked motor vehicle.

13. The method of claim 12, including increasing flashing speed of said warning light as said approaching motor vehicle comes closer to said parked motor vehicle.

14. The method of claim 13, including increasing intensity of said warning light as said approaching motor vehicle comes closer to said parked motor vehicle.

15. The method of claim 12, including increasing intensity of said warning light as said approaching motor vehicle comes closer to said parked motor vehicle.

16. The method of claim 12 including monitoring a transmission state of said parked motor vehicle and activating said collision protection system only when a transmission of said parked motor vehicle is in park.

17. The method of claim 12, including monitoring an ignition state of said parked motor vehicle and activating said collision protection system only when an ignition of said parked motor vehicle is off.

18. (canceled)

19. The method of claim 12, including reducing a flashing speed or intensity of said warning light as said approaching motor vehicle begins to move away from said parked motor vehicle.

20. The method of claim 12, including extinguishing said warning light when no further motion of said approaching motor vehicle is detected.
